(19) United States
(12) Patent Application Publication
(10) Pub. No.: US 2007/0129456 A1
(43) Pub. Date: Jun. 7, 2007

(54) Solvent-less polyurethane foam with micro pores and method of fabricating synthetic leather therefrom

(75) Inventors: Yoon-Jong Cha, Seoul (KR); Jun-Wan Im, Seoul (KR); Sung-Duck Ahn, Seoul (KR)

Correspondence Address: LERNER GREENBERG STEMER LLP, P O BOX 2480, HOLLYWOOD, FL, 33022-2480, US

(73) Assignee: Baiksan Co., Ltd.

(21) Appl. No.: 11/347,850

(22) Filed: Feb. 6, 2006

(30) Foreign Application Priority Data
Dec. 7, 2005 (KR) 10 2005 0118734

(51) Int. Cl. C08G 18/00

(52) U.S. Cl. 521/172

(57) ABSTRACT

The present invention heats to melt a urethane prepolymer (A ingredient) including a hydroxyl (—OH) functional group in a liquid state or a semi-solid state at room temperature as itself or temperature at 30° C. to 80° C., an isocyanate compound (B ingredient) for reacting with a hydroxyl functional group of urethane prepolymer, a mixture (C ingredient) of a hardening catalyst by cross-link, a pores formation assistance catalyst, a silicone surfactant, and an additive is added by fixed quantity and agitation at high speed to mix. Thus formed porous material of cream shape is using by knife coating process. Thus, the purpose of the present invention is manufacturing a solvent-less urethane porous foamed material fabricating synthetic leather as uniformity of micro pores and good mechanical properties of high strength.

### TECHNICAL FIELD

The present invention relates to a method of manufacturing formed micro pores material solvent-less urethane fabricating synthetic leather without using any solvent. In more details, a pore is better for uniformity, adhesive peel strength, UV yellowing-resisting property, a chemical-resisting property, a heat-resisting property and other properties than compound in prior art and its process. Thus a solvent-less polyurethane foam with micro pores and method of fabricating synthetic leather thereof has a good quality of uniformity due to safe operation and productivity.

### BACKGROUND ART

General fabricating synthetic leather used a method of wet-coagulation as formed pores by substitution reaction between waterborne of coagulation solution and dimethyl formamide (DMF) of solvent urethane in coagulation of DMF aqueous solution to coating and spreading a mixture solution of solvent urethane resin such as DMF. However many substitution art had been developed from organic solvent to waterborne urethane because of harmfulness on human body by strong virulence of hydrophilic organic solvent such as dimethyl formamide but the development was not satisfied with a tactile sensation and a property. Fabricating synthetic leather by waterborne urethane was limited due to heat-resistance, waterborne-resistance and mechanical property.

In order to solve the above-described problems, Japanese Patent Publication No. 2003-246830, 2003-049147, 2003-306526, 2004-115705 and Korean Patent Publication No. 2002-0050138 and PCT Publication No. WO 2003/042271 was disclosed; however it had been found some problems concerning the method of practical application and commercialization according to the result of manufacturing field with laboratory experiments.

The above-mentioned patents had been disclosed that urethane prepolymer (A ingredient) containing isocyanate functional group in a semi-solid state or a solid state is heated and melted at a temperature of about 80° C. to 150° C., then a hydroxyl functional group (B ingredient) for hardener with the isocyanate group or curing catalyst, waterborne and surfactant were mixed agitation at high speed using a mixing head to obtain formed mechanically foamed body having a cream shape. Thus formed mechanically foamed body is cooled or compressed at a room temperature for over 24 hours to prepare a polyurethane porous material.

As manufacturing method of the above-described process, the method was possible to obtain porous material with reproducibility under condition of maintaining fixed temperature, humidity and maturation. However, the porous material having a homogeneous porosity is hard to obtain if the condition of temperature, humidity and maturation was even little bit changed. Thus detailed process control was needed because the property of the porous material could be changed. Thus too much expensive equipment was needed for constant temperature and a customary habit to maintain the fixed temperature, humidity and maturation.

Moreover, in general, making porous material had a problem to make going down productivity because compound declination happened easy to become a short pot life of compound solution and a lowering stream due to relatively high viscosity and melting temperature over 80° C. of urethane prepolymer in A ingredient. In other words, the heterogeneous result of porous material became a cause of deterioration of porous material by a density and thickness of porous material. Also the method had an economical loss problem according to lowering productivity.

In addition, the shape of the urethane prepolymer containing the isocyanate functional group according to the above-described method is very susceptible to deform or to be modified through a reaction with humidity. Therefore, the storing of the urethane prepolymer is not easy.

To solve the above-mentioned problems, Korean Patent Registration No. 10-0514629, Korean Patent Publication No. 10-2005-0008550 and PCT Publication No. WO 2005/005511 disclosed a method of manufacturing urethane polyol prepolymer including two hydroxyl functional group at least, having a urethane in polymer and a semi-solid state or a solid state at room temperature as mixing and reacting 1 equivalent weight of isocyanate compound with about 1.1 to about 2.5 equivalent weight of polyol compound.

The above-mentioned method was heated and melted urethane polyol prepolymer, then an isocyanate compound including an isocyanate functional group with reacting hydroxyl of a urethane polyol prepolymer and a urethane curing catalyst are added and stirred at high speed to form mechanically foamed material of cream shape. The formed mechanically foamed body is cooled or compressed at a room temperature to prepare a polyurethane porous material. The above-mentioned patent used urethane polyol prepolymer having a hydroxyl functional group. However, a manufacturing method of polyurethane porous material was a imitation level of hot melt moisture curing system, and there was a limitation of laboratory experiment in manufacturing fabricating synthetic leather by cooled or compressed at a room temperature (Calender Roll Coating Method), was not good for productivity safety of working in the industry field and was not satisfactory of mechanically property as required in fabricating synthetic leather.

Protecting release paper was required as a necessity for protecting solvent-less formed material stick to a calender roll to be cooled or compressed at a room temperature. Thus there were problems such as many badness productions and high production cost due to high cost of protecting release paper. Also, porous polyurethane had to go through maturing process at least over 48 hours because formed porous polyurethane by cooled or compressed at a room temperature was lower a combination of cross-link cursing than cursing at a room temperature of urethane prepolymer with isocyanate functional group, even passed fixed time for the maturing process, there was a quite defect for its property.

In addition, because porous polyurethane material depended on only activity of a catalyst simple cross-link and hardening without any process, porous polyurethane material was generated unbalance foaming with lower hardening. Thus strong micro pores as its structure was hard to make formed and was not satisfied with its property as requiring in fabricating synthetic leather.

### TECHNICAL SOLUTION

An object of the present invention for overcoming the above-mentioned problems is to provide a solvent-less polyurethane foam with micro pores and method of fabricating synthetic leather to be different from solvent-less urethane blowing system in the prior art.

Another object of the present invention provides to make polyurethane porous uniform sheet, which is not influenced by a condition in temperature and humidity of processing and maturing, thus to provide to make work condition as more safety and high productivity with practical use of heat curable system to apply fixed temperature in mechanically foaming compound. The present invention also provides formed pores polyurethane has good chemical and physical properties as to minimize the variation of density and thickness of manufactures.

Another object of the present invention is to provide a polyurethane porous and method thereof to be able to reduce the cost of manufacture in economy, and to improve UV yellowing-resisting property although small amount of UV yellowing additives are added as using a UV yellowing-resisting cross-linker or UV yellowing-resisting prepolymer. Working environment is efficient as possible for knife coating at a room temperature 12° to 18° or at a fixed temperature 12° C. to 60° C. because polyurethane pores of the present invention is designed by elements as long pot life, low viscosity and good waterborne property. Therefore, mechanically foaming compound is easy to control with process condition when the polyurethane pores is coated to make a long pot life at a room temperature, and to provide a method of excellent solvent-less polyurethane fabricating synthetic leather with durability, adhesive peeling strength and the other properties.

The object of the above-described present invention is a polyurethane porous as claimed is a method of polyurethane porous as mixed with a urethane prepolymer (A ingredient) including a hydroxyl (—OH) functional group and an isocyanate compound or prepolymer containing isocyanate (B ingredient) in polyurethane porous. The isocyanate compound is an independent or a mixture of degeneration aromatic polyisocyanate, degeneration aliphatic polyisocyanate, or aliphatic isocyanate functional group (—NCO) prepolymer in a liquid state of low viscosity at a temperature 12° C. to 18° C.

### ADVANTAGEOUS EFFECTS

Solvent-less urethane type synthetic leather according to the present invention is that reproduction and chemical physical properties of matter like and productivity is superior according to hydrolysis and maturing condition than solvent-less blowing agent in the conventional art.

Also, uniformed micro pores can be formed, thus there is effect that touch and molding are good relatively and adhesive peel strength is high because strong micro pores is structurally formed.

Moreover, because properties of matter lower viscosity as is superior and did molecular theory so that pot life may be long, fixed temperature is easy though knife coating is efficient in work environment improvement effect aspect because is possible at a fixed temperature about 12° C. to about 60° C., and easy to regulate process condition because pot life is long to when coating at a room temperature about 12° C. to about 18° C.

Therefore, a good product of uniformed quality can be obtained because density of product and thickness deviation does not happen.

Adhesive peeling strength, chemical-resisting and mechanical properties are superior relatively with the conventional art of porous material formation method. Thus, it is available to use for sports shoes as required high durability, and available to use extensively for furniture, automobile and so on because it is formed micro pores as evenly.

### BRIEF DESCRIPTION OF THE DRAWINGS

The present invention will become better understand with reference to accompanying drawings which are given only by way of illustration and thus are not limitative of the present invention, wherein;

FIG. 1 is a illustrating a cross-section view of a solvent-less urethane fabricating synthetic leather according to Comparative Example 1 of the present invention.

FIG. 2 is a illustrating a cross-section view of a solvent-less urethane fabricating synthetic leather according to Comparative Example 2 of the present invention.

FIG. 3 is a illustrating a cross-section view of a solvent-less urethane fabricating synthetic leather obtained according to Embodiment 9 of the present invention.

FIG. 4 is a illustrating a cross-section view of a solvent-less urethane fabricating synthetic leather obtained according to Embodiment 13 of the present invention.

※ What the number in the main part of drawings stands for is □

101, 201, 301, 401: Micro Pores

102, 202, 302, 402: Layer of solvent-less Urethane form

103, 203, 303, 403: Fiber material (non-woven fabric)

### BEST MODE FOR CARRYING OUT THE INVENTION

The present invention of solvent-less polyurethane fabricating synthetic leather manufacturing method for achievement of the above-mentioned objects will be described in detail hereinafter.

The present invention is after A ingredient of urethane prepolymer including hydroxyl functional group, B ingredient of isocyanate compound to be able to react with the hydroxyl, and C ingredient of a hardening catalyst by cross-link, a blowing catalyst, surfactant and an additive is added, then mechanically blowing agent of cream shape is formed sheet as coating on release paper at fixed temperature about 12° C. to about 60° C., to make cross-link cursing under warming condition at about 50° C. to about 150° C. of the sheet, and compress and join with fiber machinery and materials, and then joined molding material is maturing at about 30° C. to about 110° C. for proper time after hardening by re-cross-link under warming condition at about 50° C. to about 150° C. using by knife coating process by fixed quantity and agitation at high speed to mix.

The hydroxyl functional group prepolymer as A ingredient is reacting 1 equivalent weight of polyol compound with about 0.4 to about 0.9 equivalent weight of isocyanate compound, is formed to add a TPU (Thermoplastic Polyurethane Elastomer) for adhesive peel strength. The hydroxyl functional group prepolymer as A ingredient is heated and melted at a temperature below 80° C., desirably below 60° C., and to add isocyanate compound (B ingredient) and mixture (C ingredient) of hardening catalyst by cross-link and surfactant as fixed quantity, and then apply mechanically blowing agent of cream shape by agitation at high speed to mix to coated release paper by urethane of knife coating process at a fixed temperature about 12° C. to about 60° C.

The present invention will be described with reference to accompanying drawings in detail hereinafter.

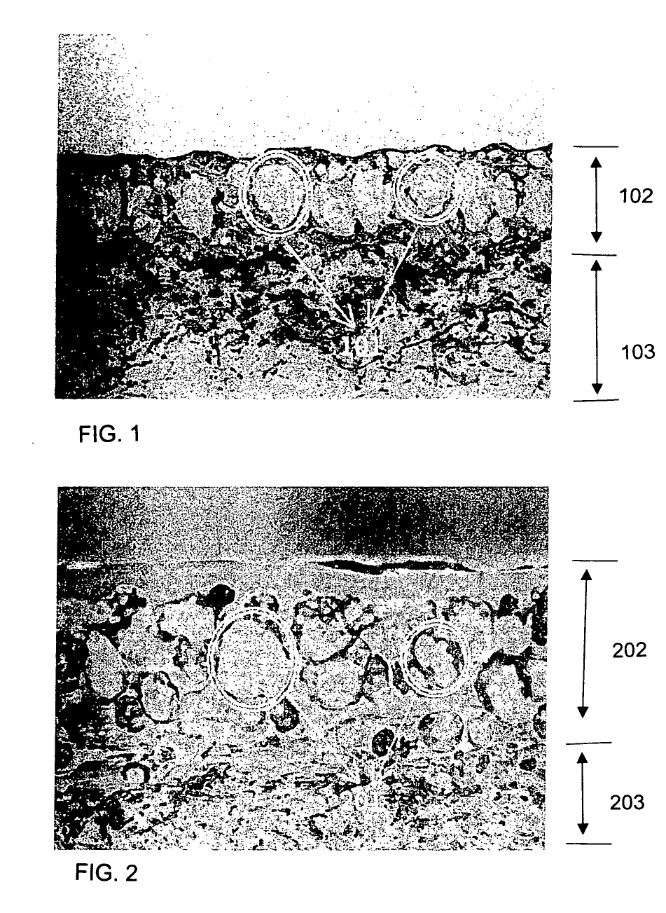

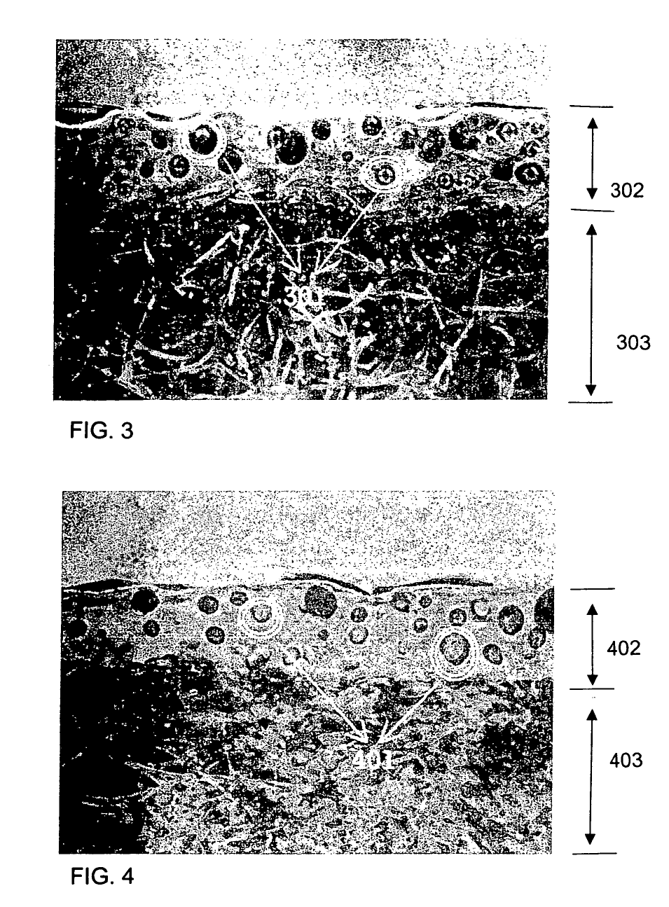

FIG. 1 is a illustrating a cross-section view of a solvent-less urethane fabricating synthetic leather according to Comparative Example 1 of the present invention. FIG. 2 is a illustrating a cross-section view of a solvent-less urethane fabricating synthetic leather after calendar roll coating according to Comparative Example 2 of the present invention. FIG. 3 (Embodiment 9) and FIG. 4 (Embodiment 13) is a illustrating a cross-section view of a solvent-less urethane fabricating synthetic leather manufactured by warming hardening in a temperature about 100° C. to about 120° C. after knife coating in a temperature about 12° C. to about 18° C. according to the present invention.

A hydroxyl functional group prepolymer as solvent-less polyurethane of the present invention is formed by a crystalline polyether polyol about 10 to about 50% by weight, a crystalline polyester polyol about 1 to about 30% by weight, a liquid amorphous polyether polyol about 5 to about 30% by weight at a room temperature about 12° C. to 18° C., an amorphous polyester polyol about 5 to about 30% by weight, TPU about 0.1 to about 10% by weight.

The hydroxyl functional group prepolymer is a liquid state or semi-solid state, a melting viscosity at a temperature 80° C. is about 2,000 to 40,000 cps, desirable malting at a temperature less than 80° C. The isocyanate compound to apply as cross-linker is including at least one group in formed by a degeneration diphenyl methane diisocyanate, a biuret aliphatic isocyanate, aliphatic isocyanureite and an aliphatic isocyanate functional group prepolymer.

Special quality of each material as applying to the present invention as follows:

1. Urethane Prepolymer (A Ingredient)

A hydroxyl functional group urethane prepolymer as applying to the present invention reacts to mix aromatic or aliphatic isocyanate and polyol, a chain extender and TPU by a proper rate, and is liquid state and semi-solid of high viscosity at a room temperature about 12° C. to about 18° C. as high molecular compound containing at least more than two hydroxyl desirably less than about 2 pieces to 4 pieces in both functional group. Hardening is not working well if a hydroxyl in urethane prepolymer is less than 2 pieces. Flexibility due to high cross-linker and working efficiency by rising viscosity due to too much quick hardening is not good if a hydroxyl in urethane prepolymer is more than 4 pieces. A hydroxyl functional group prepolymer is proper as melting viscosity is about 2,000 to 40,000 desirably 5,000 to 30,000 more desirably 6,000 to 20,000 cps at a temperature 80° C. If a melting viscosity is less than 2,000 cps at the temperature 80° C., a pore formation is difficult and hardening reaction is too slow because all property gets worse when a urethane porous material is formed, which is not desirable. If a melting viscosity is more than 40,000 cps at the temperature 80° C., working efficiency goes to down because discharging is difficult and is limited to mix uniformly in a mixing head. Urethane prepolymer is proper to melt at a temperature less than 80° C. desirably less than 60° C. considering safety, efficiency and reaction of working. In general, viscosity is too much rising because suddenly cross-link hardening reaction is occurred due to high temperature of melting resin in discharging if melting temperature of A ingredient is too high, thus an non-uniformed polyurethane porous material can be formed as an adhesive peel strength is deteriorate and a coating is uniformly difficult at a room temperature or fixed temperature because a polynomial time becomes too short. Thus a liquid state and a semi-solid state of a high viscosity at a room temperature are desirable to be able to melt at a low temperature.

A hydroxyl functional group urethane prepolymer as the above-described special quality is formed uniformly the mixing ratio of the polyol compound with respect to 1 equivalent weight of isocyanate compound, which is in a range of about 0.4 to 0.9, and is in a range of TPU about 0.5 to 10% by weight at a temperature 60° C. to 120° C. If an isocyanate functional group is less than 0.4 with respect to 1 equivalent, mechanical properties deteriorate because a molecular weight is too small. If an isocyanate functional group is more than 0.9 with respect to 1 equivalent, viscosity is too high because a molecular weight increases too much, and complete reacting by both hydroxyl of prepolymer is difficult.

A polyol used by compound of urethane prepolymer can be used polyester type polyol, polyether type polyol, lactone type polyol, polycarbonate type polyol and caster oil type particular polyol. Those type polyol can be used independent as itself or more than 2 types of polyol with proper rate. A special quality of prepolymer in the present invention exists in liquid state and semi-solid of high viscosity at a room temperature about 12° C. to about 18° C., and working safety is great due to long polynomial time. Also the present invention is designated to be able to obtain a good urethane porous material easy hardening and a good mechanical property when it is warming up by over fixed temperature.

A desirable ingredient-mixing ratio of the polyol as claimed is formed a crystallization polyether polyol about 10 to 50% by weight of polytetramethylene glycol (PTMEG), polycaprolactone (PCL), a crystallization polyester polyol about 1 to 30% by weight of hexane diol/adipic acid (HD/AA), butane diol/adipic acid (BD/AA) and a non-crystallization polyether polyol about 5 to about 30% by weight of a polypropylene glycol (PPG) in a molecular weight 400 to 6,000 of more than two groups with liquid state at a temperature 12° C. to 18° C., a non-crystallization polyester polyol about 5 to about 50% by weight of a methylpentane diol/adipic (MPD/AA) and a neopenthy glycol/adipic acid (NPG/AA) and a Thermoplastic Polyurethane Elastomer (TPU) as a wetting agent for adhesive 0.1 to 10% by weight.

A 4,4-diphenylmethane diisocyanate (MDI) is usually used for the isocyanate, but it is possible to use in combination with other diisocyanate limited by not to obstruct for an efficiency of the present invention. For instance, it can be used a compound of a degeneration MDI, a hexamethylene diisocyanate (HDI), an isophorone diisocyanate (IPDI), hydrogenated diphenylmethane diisocyanate (H12MDI), but it is not restricted on that.

A low molecular weight rate is used for a chain extender, for instance a ethylene glycol, 1,2-prophilene glycol, 1,3-prophilene glycol, 1,4-butandiol, neo-pentene glycol, 1,5-pentene diol, 1,6-hexan diol, diethylene glycol. The above-mentioned hydroxyl functional group prepolmer is rarely modified by humidity, thus a storing and managing is relatively easier than an isocyanate functional group prepolymer in the prior art.

An ester type, a caprolactone type, ether type is used for TPU, commonly 2 functional polyol as formed of a soft-segment, a single chain glycol as formed hard segment and block copolymer as formed by combination of 3 ingredient. Especially a soft segment is changed a characteristic of a mechanical strength, a heat-resisting property, a waterborne-resistance and oil-resisting property according to ester type and ether type, and hardness, an elastic modulus and a heat-resisting property is affected by hard-segment. The TPU 0.1 to 10% by weight is added. A crystallization speed of polyurethane porous material is fast if TPU content is more than 10% by weight, thus the problem is not only working safety is not good but also a heat-resisting property is lower as well. Adhesive peel strength is not good if TPU content is less than 0.1% by weight.

2. Isocyanate Functional Group Contained Compound (B Ingredient)

As hydroxyl functional group urethane prepolymer's cross-linker can mix and use more than carbodiamide modification MDI (Methylene diphenyl diisocyanate) or isocyanate functional group prepolymer singleness or 2 that have isocyanate action account that can react with hydroxyl during molecular structure, burette type HDI (Hexamethylene diisocyanate), isocyanureite type HDI, modification IPDI (Isophorone diisocyanate) as for acted isocyanate type inorganic compounds.

The above-described isocyanate type inorganic compounds use about 1.05 to about 2.5 for 1 equivalent of the urethane prepolymer. Because cross-linking and hardening degree is insufficient if it is less than 1.05 equivalents porous properties of matter and a heat-resisting decline phenomenon about urethane prepolymer 1 equivalent are happened, and if is more than 2.5 equivalents, because cross-linking degree is so excessive, softness drops and much quantity of the isocyanate remaining amount exist and sulfur-resisting properties, chemical-resisting properties, product randomicity can present.

The problem exists, as general aromatic isocyanate cross-linker is that a sulfur-resisting property is bad, and color is changed yellow according as time passes. Therefore, burette type HDI, isocyanureite type HDI or aliphatic isocyanate functional group by cross-linker to do so that improve these problem and properties of matter form superior porous.

3. Urethane Reaction Catalyst (C Ingredient)

As known to the prior art as for urethane gelation catalyst, organic metal catalyst of dibutyltin dilaurate (DBTDL) can be used the third amine inorganic compounds of thrietylenediamin (TEDA), dimethylcyclohexylamine (DMCHA) and so on, and can use vitality catalyst (Thermally Activated Catalyst) by effective temperature to hardening system that also goes and use jointly with blowing catalyst. Amount used of urethane gelation catalyst is about 0.01 to about 5 weights about urethane prepolymer 100 weights. If the amount used of urethane gelation catalyst is less than 0.01 weights, blowing and film formation do not become well because cross-linking hardening reaction is so slow. If the amount used of urethane gelation catalyst is more than 5 weights, instantaneously gelation is done, thus work productivity is bad because cross-linking hardening reaction is so fast.

4. Surfactant (C Ingredient)

That is informed to as for Surfactant in the prior art, for instance can use trade name as DC-190, DC-5098 (Dow Corning, silicone glycol copolymer). Amount used is about 0.1 to about 10 by weight of urethane prepolymer 100 by weight, desirably about 0.5 to about 5 by weight, more desirably about 1 to about 3 by weight. If surfactant content is less than 0.1 by weight, synthetic foam is difficult to be formed. If surfactant content is more than 10 by weight, mechanical properties of matter by unmeasured start of work are fallen because synthetic foam is formed so much.

Porous Polyurethane and Method of Fabricating Synthetic Leather

After do hydroxyl functional group urethane prepolymer (A ingredient) to do heating melting at suitable temperature, is kept at optimum temperature in heating vessel. Isocyanate type compounds (B ingredient) and cross-link hardening catalyst and surfactant mixture (C ingredient) kept at a room temperature about 12° C. to about 18° C. or 30° C. in heating vessel continuously. Next, agitate high speed for 2 or 5 seconds by 4,000 or 5,000 rpm and got mechanical foam of cream shape after urethane prepolymer, isocyanate type compounds and, surfactant and hardening catalyst make fixed quantity injection by fixed quantity. The above-described formed mechanical foam is compressed with fiber material after heating and hardening during optimum time at a temperature about 50° C. to about 150° C. spreading on release paper coated by solvent type or mercury urethane. After is aged for 24 hours at optimum temperature, manufactured fabricating synthetic leather as micro pores is formed evenly make and external appearance is graceful with exfoliating release paper. That temperature extent of hydroxyl functional group urethane prepolymer or isocyanate compounds ingredient in a mixing head (agitation at high speed to mix functional group) is good at a temperature about 30° C. to about 80° C. in detail, more desirably at a temperature about 30° C. to about 60° C. especially considering about coating at a temperature about 12° C. to about 18° C., which does not give a trouble in that circulate 2 liquid functional group.

Preferred embodiments of the present invention will be described in more detail below. However, it should be understood that the present invention is not limited to the following Examples. Percent sign % of embodiments and examples is presented % by weight if there is no description.

### COMPARATIVE EXAMPLE 1

To do heating and melting isocyanate functional group urethane prepolymer (available in the market as a trade name Daiposeu NH-200 Dainippon Ink Chemical (DIC) Co. Ltd., ether type urethane prepolymer, NCO content 3.5±0.5%) at a temperature 120° C., and keep by 120° C. in heating tank, and after keep by 30° C. in tank that mix trade name Mitsui-polyol ED-200 (polyetherpolyol, hydroxyl value 36±2 mg KOH/g, manufacturer by Mitsui chemical Co., Ltd.) evenly combining trade name U-CAT SA 506 (manufacturer by San-Apro Inc.) by hardening catalyst of 2 files amidine inorganic compounds and trade name SF-2944 F (manufacturer by Toray Dow coning Silicone) as surfactant by the rate 50:20:30, then ingredient A and B available such as ISM-206H (Perfection Mighty Industrial CO., LTD. in Taiwan) that is heated in 120° C. by special line to make the rate as 100:5 for the ingredient A and B of mixing head by fixed quantity pump so that mix to be stirred at high speed for 1 second by 5,000 rpm. To be able to make that density of mixture is to amount to 0.5, formed foam such as cream shape with agitation at high speed during 2 seconds by on release paper which spread and dried by urethane outer skin (trade name: FINE UB-501MA, manufacturer: Fine Chemistry) of 30 μm, and spread using by calender roll, then compressed and cooled urethane non-woven fabric of thickness 1.0 mm after leave the foam for about 3 minutes in room temperature. After leave for 2 days at room temperature, have taken off the release paper and obtained fabricating synthetic leather. These method in mixing head circulation must make done mixed liquor minimize pot life so that can minimize contact with moisture, produce controversial point that flowing department of mixed liquor separates thereby and because match deviation is easy to happen, thus work stability grows worse. Therefore, because porous material's density and thickness deviation happen, because quality of the material is not uniformed, there is shortcoming that fair dissipation can occur in economical vantage point because quality is dwindled and production efficiency is low. Also, there was difficulty to be formed micro pores in uniformity by compressing or cooling by normal temperature.

### COMPARATIVE EXAMPLE 2

Urethane polyol prepolymer (obtained by the method of Comparative Example 1 disclosed in Korean Patent Registration No. 10-0514629) is heated and melted at a temperature 120° C., then was kept at a temperature 120° C. in a heating vessel. Continuously isocyanate compounds [trade name COSMONATE LL (Kumho Mitsui Chemicals, inc.)], amine hardening catalyst [trade name PC CAT TD 33 (Nitroil company, Germany)] and surfactant [trade name DC-193 (Dow corning)] by 5:30 relationships % by weight was kept mixed mixture at a temperature 30° C. in heating vessel. Continuously, after input urethane polyol prepolymer, isocyanate compound and amine hardening catalyst, and surfactant compound of fixed quantity to become % by weight of 85:17:18 about totally 100% by weight at a temperature 120° C., was formed mechanical foam in density 0.3 to be stirred at high speed for 2 second by 5,000 rpm. Also, after spread formed machine foam on release paper, application thickness compressed using mangle roll so that may become 300 μm with putting in another release paper on the spread material, and obtained porous polyurethane that thickness is 300 μm having uniformed and micro porous cooling at a room temperature. As method to be compressed at normal temperature after the described manufacturing process depends on vitality of catalyst, because obtained polyurethane porous is hard to be formed evenly micro pores, because hardening is to be slow and blowing is to be low, thus lot deflection of product and physical properties of matter is difficult to satisfy the mentioned matter that could be happened. Also, to be able to become shortcoming production efficiency that must pass through ripening procedure more than smallest 48 hours because a hardening is slow.

### EXAMPLE 1

Hydroxyl functional group urethane prepolymer [available in the market as a trade name ELP-023, BaikSan Co. Ltd., PTMG, MPD/AA, 3 senses flag PPG-3000, TPU (trade name: PERLBOND DIPP-539, manufacturer: MERQUINSA company, liner polycaprolactone polyurethane) and MDI type Prepolymer, OH Content 2.1%, viscosity 12,000 cps/60° C.] is heating and melting at a temperature 50° C., then is kept by a temperature 50° C. in heating vessel. Isocyanate compound as B ingredient [available in the market as a trade name Desmodur-VH 20, Bayer Co., Ltd. NCO 25%] and C ingredient match by 2:15 and mixed evenly available as a trade name TOYOCAT-TF and TOYOCAT-DB30 (manufacturer: TOSOH CORPORATION) and surfactant available as a trade name Dow Corning® 5098 (Manufacturer: Dow Corning Co., Ltd. Silicone). After that, ingredient A, B and C by special line in a main molding vessel of ISM-206H (Perfection Mighty Industrial CO., LTD., Taiwan) ingredient A, B and C pour by fixed quantity pump so that may become 100:13:1.52 and agitate high speed for 3 seconds by 5,000 rpm and got mechanical blowing agent of cream shape. Discharging on release paper to be spread and dried Foam of cream shape by oil nature urethane outer skin (available as a trade name FINE UB-501MA, Manufacturer: Fine Chemistry) and coating to be able to have porous polyurethane thickness 400 μm in complete production, then contact and compress urethane non-woven fabric of thickness 1.0 mm after dry heating for optimum time at a temperature about 100° C. to about 120° C. After leave for 1 day at optimum temperature, have taken off release paper and obtained fabricating synthetic leather.

### EXAMPLE 2 TO 14

As content such as table 1 below, as changing the match amount and hydroxyl functional group prepolymer by process condition, kind and content quantity of cross-linking hardening, got result as table 2 to manufacture fabricating synthetic leather by uniformed method such as the above described of Example 1.

TABLE 1
Match of solvent-less urethane blowing agent and procedure condition of fabricating synthetic leather

| | | | | Cross- | | | |
|---|---|---|---|---|---|---|---|
| | | | | linking | | | |
| | Prepolymer | Cross-linker | Surfactant | Catalyst | Coating | Cross-linking/ | Maturing |
| | (weight) | (weight) | (weight) | (weight) | Method | Dry Condition | Condition |
| Comparative | NH-200 | Mitsui Polyol | SF-2944F | CAT-SA | Calender | Room temperature | Room temperature |
| Exmaple 1 | (100) | ED-200 | (1.5) | 506(1.0) | Roll | (12-18° C.) | (12-18° C.) |
| | | (2.5) | | | | Cross-linking | for 48 hours |
| Comparative | Korean Patent | COSMONATE | DC-193 | PC CAT TD | Calender | Room temperature | Room temperature |
| Exmaple 2 | Registration | LL(20) | (1.8) | 33(0.3) | Roll | Cross-linking | for 48 hours |
| | No. 0514629 - | | | | | | |
| | Example 1 | | | | | | |
| Example 1 | ELP-023 | Desmodur - | DC-5098 | Toyocat-TF | Knife | 90-130° C. | 60° C. for |
| | (100) | VH 20 (13) | (1.5) | Toyocat- | | Cross-linking | 24 hours |
| | | | | DB30(0.2) | | | |
| Example 2 | ELP-024 | Desmodur - | DC-5098 | Toyocat-TF | Knife | 90-130° C. | 60° C. for |
| | (100) | VH 20 (13) | (1.5) | Toyocat- | | Cross-linking | 24 hours |
| | | | | DB30(0.2) | | | |
| Example 3 | ELP-025 | Desmodur - | DC-5098 | Toyocat-TF | Knife | 90-130° C. | 60° C. for |
| | (100) | VH 20 (13) | (1.5) | Toyocat- | | Cross-linking | 24 hours |
| | | | | DB30(0.2) | | | |
| Example 4 | ELP-026 | Desmodur - | DC-5098 | Toyocat-TF | Knife | 90-130° C. | 60° C. for |
| | (100) | VH 20 (13) | (1.5) | Toyocat- | | Cross-linking | 24 hours |
| | | | | DB30(0.2) | | | |
| Example 5 | ELP-026 | COSMONATE | DC-5098 | Toyocat-TF | Knife | 90-130° C. | 60° C. for |
| | (100) | LL(13) | (1.5) | Toyocat- | | Cross-linking | 24 hours |
| | | | | DB30(0.2) | | | |
| Example 6 | ELP-026 | Duranate | DC-5098 | Toyocat-TF | Knife | 90-130° C. | 60° C. for |
| | (100) | 24A (15) | (1.5) | Toyocat-DB30 | | Cross-linking | 24 hours |
| | | | | Dabco TMR-2 | | | |
| | | | | (0.2) | | | |
| Example 7 | ELP-026 | Coronate | DC-5098 | Toyocat-TF | Knife | 90-130° C. | 60° C. for |
| | (100) | HK (15) | (1.5) | Toyocat-DB30 | | Cross-linking | 24 hours |
| | | | | Dabco TMR-2 | | | |
| | | | | (0.2) | | | |
| Example 8 | ELP-030 | Desmodur - | DC-5098 | Toyocat-TF | Knife | 90-130° C. | 60° C. for |
| | (100) | VH 20 (13) | (1.5) | Toyocat-DB30 | | Cross-linking | 24 hours |
| | | | | Dabco TMR-2 | | | |
| | | | | (0.25) | | | |
| Example 9 | ELP-030 | COSMONATE | DC-5098 | Toyocat-TF | Knife | 90-130° C. | 60° C. for |
| | (100) | LL(13) | (1.5) | Toyocat-DB30 | | Cross-linking | 24 hours |
| | | | | Dabco TMR-2 | | | |
| | | | | (0.2) | | | |
| Example 10 | ELN-020 | COSMONATE | DC-5098 | Toyocat-TF | Knife | 90-130° C. | 60° C. for |
| | (100) | LL | (1.5) | Toyocat- | | Cross-linking | 24 hours |
| | | | | DB30(0.25) | | | |
| Example 11 | ELN-020 | Duranate | DC-5098 | Toyocat-TF | Knife | 90-130° C. | 60° C. for |
| | (100) | 24A (15) | (1.5) | Toyocat-DB30 | | Cross-linking | 24 hours |
| | | | | Dabco TMR-2 | | | |
| | | | | (0.25) | | | |
| Example 12 | ELN-020 | Coronate | DC-2583 | Toyocat-TF | Knife | 90-130° C. | 60° C. for |
| | (100) | HK (15) | (1.5) | Toyocat-DB30 | | Cross-linking | 24 hours |
| | | | | Dabco TMR-2 | | | |
| | | | | (0.25) | | | |
| Example 13 | ELN-022 | COSMONATE | DC-2583 | Toyocat-TF | Knife | 90-130° C. | 60° C. for |
| | (100) | LL | (1.5) | Toyocat-DB30 | | Cross-linking | 24 hours |
| | | | | Dabco TMR-2 | | | |
| | | | | (0.25) | | | |
| Example 14 | ELN-022 | Duranate | DC-2583 | Toyocat-TF | Knife | 90-130° C. | 60° C. for |
| | (100) | 24A (15) | (1.5) | Toyocat-DB30 | | Cross-linking | 24 hours |
| | | | | Dabco TMR-2 | | | |
| | | | | (0.25) | | | |

ELP-023: BaikSan Co., Ltd., PTMG, AA/IPA/EG/DEG/NPG, PPG-3000 (3F) and MDI type prepolymer, OH Content 2.3%, viscosity 15,000 cps/60° C.
ELP-024: BaikSan Co., Ltd., PTMG, AA/EG/PG/GL, PPG-3000 (3F) and MDI type prepolymer, OH Content 2.3%, viscosity 18,000 cps/60° C.
ELP-025: BaikSan Co., Ltd., PTMG, AA/EG/DEG, NPG/AA, PPG-3000 (3F) and MDI type prepolymer, OH Content 2.4%, BaikSan viscosity 13,000 cps/60° C.
ELP-026: BaikSan Co., Ltd., PTMG, AA/IPA, PPG-3000 (3F) and MDI type prepolymer, OH Content 2.2%, viscosity 21,000 cps/60° C.
ELP-030: BaikSan Co., Ltd., PTMG, AA/IPA/NPG, PPG-3000 (3F), PEARLBOND DIPP-539 (TPU) and MDI type prepolymer, OH Content 2.2%, viscosity 15,000 cps/60° C.
ELP-031: BaikSan Co., Ltd., PTMG, MPD/AA, PPG-3000 (3F) and MDI type prepolymer, OH Content 2.3%, viscosity 13,000 cps/60° C.
ELN-020: BaikSan Co., Ltd., PTMG, PCL, AA/BD/EG, PPG-5000 (3F) and HDI type prepolymer, OH Content 2.7%, viscosity 12,000 cps/60° C.
ELN-022: BaikSan Co., Ltd., PTMG, PCL, AA/BD/EG, PPG-5000 (3F), PEARL-BOND DIPP-539 (TPU) and HDI type prepolymer, OH Content 2.3%, viscosity 13,500 cps/60° C.
Cosmonate LL: Gumho Mitsui Chemistry, Modified MDI, NCO Content 28.5-29.5%
Coronate HK: Nippon Polyurethane Ind. Co., Isocyanureite Type HDI, NCO Content 19-20%
Desmodur VH-20: Bayer, Modified MDI, NCO Content 25%,
Duranate 24A: Asahi Kasei Chemicals, Biuret Type HDI, NCO Content 2.3%, 1,800 cps/23° C.

TABLE 2
Solvent-less Urethane Blowing agent and Properties of fabricating synthetic leather

| | | | | Cycles | | Molding | | |
|---|---|---|---|---|---|---|---|---|
| | Adhesive Peel Strength (kgf/cm) | | | Room | Hydrolysis | heat- | | |
| | Maturing | Maturing | Maturing | temperature | after 1 | resistance | UV yellowing- | |
| | for 1 day | for 2 days | for 5 days | (12-18° C.) | week | (180° C.) | resisting property | |
| Comparetive | 1.5-2.3 | 1.8-2.7 | 2.3-3.2 | 150,000↑ | 85,000 | ◯ | 2.5-3.0 | class |
| Example 1 | | | | | | | | |
| Comparetive | 1.3-2.2 | 1.5-2.5 | 1.8-2.7 | 130,000- | 80,000 | ◯ | 2.5-3.0 | class |
| Example 2 | | | | 150,000 | | | | |
| | | | | times | | | | |
| Example 1 | 3.2-3.3 | 3.7-4.0 | — | 150,000↑ | 100,000↑ | ⊚ | 3.5 | class |
| Example 2 | 3.0-3.3 | 3.4-3.7 | — | 150,000↑ | 100,000↑ | ⊚ | 3.5 | class |
| Example 3 | 3.3-3.6 | 3.8-4.3 | — | 150,000↑ | 100,000↑ | ⊚ | 3.5 | class |
| Example 4 | 3.4-3.7 | 4.0-4.4 | — | 150,000↑ | 100,000↑ | ◯ | 3.5 | class |
| Example 5 | 3.6-3.9 | 4.1-4.5 | — | 150,000↑ | 100,000↑ | ⊚ | 3.5 | class |
| Example 6 | 3.0-3.2 | 3.4-3.7 | — | 150,000↑ | 100,000↑ | ⊚ | 4 | class |
| Example 7 | 3.0-3.3 | 3.5-3.8 | — | 150,000↑ | 100,000↑ | ◯ | 4 | class |
| Example 8 | 3.8-4.1 | 4.2-4.5 | — | 150,000↑ | 100,000↑ | ◯ | 3.5 | class |
| Example 9 | 4.0-4.3 | 4.5-4.8 | — | 150,000↑ | 100,000↑ | ⊚ | 4 | class |
| Example 10 | 3.4-3.7 | 3.9-3.2 | — | 150,000↑ | 100,000↑ | ⊚ | 4 | class |
| Example 11 | 3.2-3.4 | 3.5-3.9 | — | 150,000↑ | 100,000↑ | ⊚ | 4.5 | class |
| example 12 | 3.0-3.2 | 3.4-3.7 | — | 150,000↑ | 100,000↑ | ◯ | 4.5 | class |
| Example 13 | 3.7-4.0 | 4.2-4.5 | — | 150,000↑ | 100,000↑ | ⊚ | 4 | class |
| Example 14 | 3.5-3.8 | 4.0-4.4 | — | 150,000↑ | 100,000↑ | ⊚ | 4.5 | class |

⊚ Very good,
◯ good
* Flanking strength (kgf/cm): Measurement method measured by DIN 53357, ASTM D 2724, ST-06 (Adidas method of measurement), and Adidas Company requires more than 3.5 kgf/cm.
** Flexuosity (cycle): Measurement method measured by DIN 53351, GE-24 (Adidas method of measurement), and Adidas Company requires more than 150,000th.
*** A sulfur-resisting property (class): Measurement method measured by ASTM D 1148, FT-01 (Adidas method of measurement), and Adidas Company requires more than 4.0 class.
**** Hydrolysis: Measurement method measured by DIN 53543, Satra CM 44, GE-08 (Adidas method of measurement), and Adidas Company requires more than bends 100,000 times after 1 copy hydrolysis.

As is confirmed in the descriptions table 2, that go at optimum temperature harden and Example that is aged system can know than Comparative Example (room temperature setting/room temperature compression or room temperature maturing system) that adhesive peel strength and mechanical properties of matter, heat resistance and sulfur-resisting properties are efficient in productivity aspect is superior. Also, adhesive peel strength of Comparative Example 1 and 2 can know that lowest value and deflection of best value are serious. This shows problem about uniformity of product.

As the above-described desirable examples of the present invention, solvent-less polyurethane foam with micro pores and method of fabricating synthetic leather, however the present invention is not limited to the above embodiment. As the present invention may be embodied in several forms without departing from the spirit or essential characteristics thereof, it should also be understood that the above-described examples are mot limited by any of the details of the foregoing description, unless otherwise specified, but rather should be constructed broadly within its spirit and scope as defined in the appended claims, and therefore all changes and modifications that fall within the meets and bounds of the claims, or equivalences of such meets and bounds are therefore intended to be embraced by the appended claims.

1. A solvent-less polyurethane foam with micro pores and method of fabricating synthetic leather, comprising:
a step (a) in which is compounded urethane prepolymer A ingredient including a liquid or a semi-solid hydroxyl functional group at a room temperature to be displayed a melting viscosity about 2,000 to about 40,000 cps under 80° C. to react isocyanate about 0.4 to 0.9 equivalent in polyol 1 equivalent that is consisted of a crystalline polyether polyol about 10 to about 50% by weight, a crystalline polyester polyol about 5 to about 30% by weight, a liquid amorphous polyether polyol about 5 to about 30% by weight at a room temperature about 12° C. to 18° C., an amorphous polyester polyol about 5 to about 30% by weight, TPU (Thermoplastic Polyurethane Elastomer) about 0.1 to about 10% by weight is formed in polyol 1 equivalent;
a step (b) in which is melted compounded urethane prepolymer in the step (a) under 80° C.;
a step (c) in which is mixed and stirred at high speed with C ingredient including cross-link gelling/curing catalyst, blowing catalyst, surfactant and additive, and with B ingredient to use mixing as a single or more than 2 of a carbodiamide modification MDI (Methylene diphenyl diisocyanate), burette type HDI (Hexamethylene diisocyanate), Isocyanureite type HDI (Hexamethylene diisocyanate), modification IPDI (Isophorone diisocyanate) or an isocyanate functional group, that is as an isocyanate compound to be able to react with the hydroxyl functional group.
a step (d) in which is formed a mechanical blowing agent of cream shape as discharging a mixed liquor in the step (c) to exterior;
a step (e) in which is coating the mechanical blowing agent in the step (d) at a temperature 12° C. to 60° C. as knife or comber coating on a urethane coating side on a release paper, which is coated by an solvent-based urethane or a water-based urethane;
a step (f) in which is laminating as compressing after joining each other with a fiber material to do 1st cross-link gelling/curing the mechanical blowing agent in the step (e) under a heat condition of about 50° C. to about 150° C.;
a step (g) in which is aging at about 30° C. to 110° C. after to do 2nd cross-link hardening joined blowing agent in the step (f) under a heat condition of about 50° C. to about 150° C.

2. As claimed in claim 1, wherein the method of solvent-less urethane foam fabricating synthetic leather, comprising:
a step in which is compressed with a fiber material after dry heating at temperature of 50° C. or 150° C. spreading a mechanical blowing agent of cream shape which is obtained by stirred at high speed on a release paper which is coated by a urethane, after fixed quantity injection of an isocyanate compound (B ingredient) and a cross-link hardening catalyst and a surfactant compound (C ingredient) with urethane functional group prepolymer as A ingredient of the step (a);
a step in which is re-hardening compressed fabricating synthetic leather at a temperature about 50° C. to about 150° C. after the above-mentioned step;
a step in which is aging porous sheet at a temperature about 30° C. to about 110° C. after the above-mentioned step.

3. As claimed in claim 1, wherein the method of solvent-less urethane foam with micro pores and fabricating synthetic leather, comprising:
a knife or comber coating as a melting hydroxyl functional group prepolymer in A ingredient of the step (a) at a temperature 80° C. below and the isocyanate compound in B ingredient is about 1.05 to about 2.5 equivalent weight of the urethane prepolymer based on about 1 equivalent weight, the surfactant and a catalyst compound which is stirred at high speed at a temperature about 12° C. to 60° C.

4. As claimed in claim 3, wherein the method of solvent-less urethane foam with micro pores and fabricating synthetic leather, comprising:
a cross-link gelling/curing reaction catalyst uses a thrietylenediamin (TEDA), a third amine inorganic compounds of a dimethylcyclohexylamine (DMCHA), an organic metal catalyst of dibutyltindilaurate (DBTDL), and also amount used of urethane gelation catalyst is about 0.01 to about 5 weights about urethane prepolymer 100 weights.

5. As claimed in claim 1, wherein the method of solvent-less urethane foam with micro pores and fabricating synthetic leather, comprising:
the C ingredient as surfactant is using about 0.1 to about 10 weight in case of urethane prepolymer 100 weight of silicone type non-ionic surfactant without having a hydroxyl.

6. A solvent-less polyurethane blowing agent in which is manufactured by the method of solvent-less urethane fabricating synthetic leather with micro pores as claimed in claim 1 to 5.
